(19) United States
(12) Patent Application Publication
(10) Pub. No.: US 2024/0001391 A1
(43) Pub. Date: Jan. 4, 2024

(54) DEVICE FOR CHANGING MEDIA CONNECTIONS

(71) Applicant: ESS Holding GmbH, Steyr (AT)

(72) Inventors: Alireza Eslamian, Steyr (AT); Martin Schifko, Steyr (AT)

(21) Appl. No.: 18/030,068

(22) PCT Filed: Oct. 8, 2021
(86) PCT No.: PCT/AT2021/060368

§ 371 Date: Apr. 3, 2023

(30) Foreign Application Priority Data
Oct. 14, 2020 (AT) A50883/2020

(51) Int. Cl. B05B 12/14

(52) U.S. Cl. CPC B05B 12/149

(57) ABSTRACT

A device for changing processing media has a plurality of supply connections (2) that are arranged on a common carrier (1) and that are displaceable with respect to a tool coupling (3) in a displacement direction (6). Even in the case of a large number of supply connections (2) for the processing media, both a compact design and also a quick change of these supply connections (2) is possible where the carrier (1) is traversed by line segments (4) that, on the one carrier outer side, have supply connections (2) and, on the opposite carrier inner side, have coupling attachments (5) for coupling receptacles (8) of the tool coupling (3) that are arranged on the lateral surface, said tool coupling being mounted so as to be rotatable about an axis of rotation (7) that extends parallel to the carrier (1) and normal to the displacement direction (6).

### FIELD OF THE INVENTION

The invention relates to a device for changing processing media having a plurality of supply connections which are arranged on a common carrier and which are displaceable with respect to a tool coupling in a displacement direction.

### DESCRIPTION OF THE PRIOR ART

EP1245295B1 describes a device for changing processing media, namely different paint colors. For this purpose, supply connections of different paint colors are provided on a rotatably mounted carrier. By rotating the carrier, the supply connections can be displaced relative to a tool coupling which is flow-connected to a coating device. In this way, the coating device can be supplied with different paint colors. A disadvantage of this, however, is that in addition to a drive for rotating the carrier, a linear drive must also be provided for coupling or uncoupling the supply connections and the tool coupling, which on the one hand has a negative effect on the speed of changing the paint colors and on the other hand means that additional space is required. In addition, cleaning and rinsing the tool coupling is time-consuming.

### SUMMARY OF THE INVENTION

The invention is thus based on the object of proposing a device for changing processing media of the type described at the beginning, which permits both a compact design and rapid changing of these supply connections even with a large number of supply connections for the processing media.

The invention solves the set object in that the carrier is traversed by line segments which, on the one carrier outer side, have supply connections and, on the opposite carrier inner side, coupling attachments for coupling receptacles of the tool coupling which are arranged on the lateral surface, which tool coupling is rotatably mounted about an axis of rotation which extends parallel to the carrier and normal to the displacement direction. As a result of these measures, the carrier extends at least in sections tangentially to the lateral surface of the tool coupling, so that when the carrier is displaced, the coupling attachments arranged on the carrier inner side pivot into the coupling receptacles of the tool coupling, thus achieving a fluid-tight connection between the supply connection and the tool coupling. If the carrier is held in this coupled position, various devices can be supplied with a machining medium via the supply connections. By further displacing the carrier, the coupling attachment is pivoted out of the coupling receptacle, whereby the fluid-tight connection is cancelled and the carrier can be moved further for pivoting a supply connection located upstream in the displacement direction of the carrier into a coupling receptacle located upstream in the rotation direction of the tool coupling. Both the displacement of the supply connections and the coupling and uncoupling of their coupling attachments can therefore be performed by displacing the carrier in only one direction with extremely small travel distances. For this purpose, a linear or rotary drive can be used for the carrier, or the tool coupling itself can be driven. When the tool coupling is driven, in a particularly preferred embodiment the carrier is entrained by a frictional and/or positive connection. The coupling receptacles are arranged on the lateral surface, in particular circumferentially, around the tool coupling, which is cylindrical, for example. It probably does not need to be mentioned further that this arrangement or the spacing of the coupling receptacles from one another must be selected in such a way that it is possible to pivot the coupling attachments, which are arranged one behind the other on the carrier in the direction of displacement and are spaced apart from one another, into the coupling receptacles. Due to the simple pivot-in and pivot-out mechanism resulting from the rotational movement of the tool coupling, the design of the coupling receptacles and the coupling attachments can be simple, wherein care must only be taken to ensure adequate sealing by means of an appropriate surface pressure of an intermediate seal. Due to the simple design and the short travel distances, the device according to the invention results in only a relatively small additional flow volume for the processing media, so that not only a highly dynamic processing media supply is made possible, but also a rapid cleaning of the flow volume, for example by applying a vacuum or by flushing with a cleaning agent, can be carried out. To prevent unintentional leakage of the processing media during pivoting in and out, the coupling receptacles can be provided with check valves.

Various coating media, such as liquid, powder coating or the like, but also a vacuum can be used as processing media, which are made available via the supply connections, whereby both the tool coupling itself and lines connected to the device via the tool coupling can be extracted or cleaned.

In order to enable a structurally simple supply of processing media to an atomizing device without causing losses in terms of the changeover speed of the different processing media, it is proposed that the tool coupling is flow-connected to a supply line and/or a discharge line of an atomizing device. For this purpose, the tool coupling can rotate about a hollow shaft, which is flow-connected to the supply line and/or discharge line. In this case, the hollow shaft can have openings on the jacket side for flow connection with the tool coupling, wherein the openings are arranged in such a way that a fluid connection between coupling receptacles and the hollow shaft is only possible when the coupling receptacle is fully coupled to a coupling attachment, i.e. the coupling receptacle axis is aligned, for example, perpendicular to the displacement direction of the carrier. This allows the atomizing device to be supplied with different coating agents as processing medium on the one hand and to be cleaned by applying a vacuum between the use of different coating agents on the other hand, thus preventing mixing of these different coating agents.

Atomizing devices known in the prior art use air injection or air extraction to influence the flow direction of the atomized processing medium particles and thus achieve improved application of the processing media to a workpiece. In order that the device according to the invention can be used for such atomizing devices, it is recommended in a particularly practicable embodiment that two tool couplings are provided, one of which is flow-connected to the supply line of an atomizing device and one of which is flow-connected to the discharge line of an atomizing device. In this way, two supply connections can be connected to an atomizing device. One of the supply connections can supply the atomizing device with a coating agent via a supply line flow-connected to the first tool coupling, while another supply connection can simultaneously supply the atomizing device with positive or negative pressure to influence the flow behavior of the atomized coating agent particles via a discharge line flow-connected to the second tool coupling. In addition, before changing the coating agent and thus the supply connection, the supply connection flow-connected to the discharge line can be used for suction and cleaning of the lines and the atomization device without requiring a displacement of the carrier for this purpose. A cyclone for separating and recycling the extracted operating medium residues can be installed downstream of the supply connections in the direction of flow of the operating medium. In principle, a common carrier can be provided for both tool couplings, or a separate carrier can be assigned to each tool coupling, so that one carrier can, for example, have supply connections for supplying a coating agent as the processing medium and the other carrier can have supply connections for supplying positive or negative pressure as the processing medium. The carriers can move synchronously or independently of each other. The same naturally applies to the rotatable tool couplings.

In order to keep the travel distances short when changing the supply connections despite the increasing number of supply connections, two carriers for the coupling attachments can be provided opposite each other with respect to the tool coupling. This means that the tool coupling can be connected in a fluid-tight manner to coupling attachments from two sides. In order not to interfere with the rotation of the tool coupling, the opposing carriers must have displacement directions in opposite directions. Particularly favorable design conditions result if the opposing carriers are two runs of a rotating belt drive, since on the one hand only one drive can be used to drive both carriers and on the other hand particularly favorable conditions result with regard to a slip-free frictional connection between the tool coupling and the carrier.

A particularly fast changeover between different processing media can be achieved if the coupling attachments of one carrier are staggered relative to the coupling attachments of the opposite carrier. This further shortens the travel of the carrier with a correspondingly complementary arrangement of the coupling holders on the tool coupling. When the carriers are moved, the coupling attachments of the first carrier and the coupling attachments of the second carrier, which is opposite the first carrier with respect to the tool coupling, are brought into engagement with the coupling receptacles of the tool coupling in alternation.

Particularly compact design conditions result if the carrier extends in a longitudinal direction and the atomizing device is positioned downstream of the carrier and the tool coupling in this longitudinal direction. In this way, the device for changing processing media can be built into a robot arm and a particularly variable atomizing device can be created.

The device according to the invention can be used in particular for an atomizing device for a coating agent having a coating agent carrier subjected to vibration by an exciter, wherein the coating agent carrier is an atomizing membrane driven by a rotary drive and subjected to vibration by sound waves from the exciter. As a result of these measures, the coating agent provided via the supply line is evenly distributed on the surface of the atomizing membrane by the centrifugal force generated when the atomizing membrane rotates. Since the centrifugal force is only used to distribute the coating agent, but not to detach it, the rotational speed can be selected to be relatively low, thus enabling energy-saving operation. In order to achieve uniform distribution of the coating agent over the entire surface of the atomizing membrane, the application of the coating agent can preferably be carried out in the center of the atomizing membrane. Due to the uniform thickness of the coating agent distributed on the atomizing membrane, the energy required to detach and atomize the coating agent is approximately the same over the entire surface of the atomizing membrane. The required energy input is provided by an exciter whose generated sound waves cause the atomizing membrane to vibrate. The sound waves propagate preferably through the air between the exciter and the atomizing membrane, which is why an installation-free sound propagation channel can be provided between the exciter and the atomizing membrane. In this context, installation-free means that there are no installations in the sound propagation channel that negatively influence the propagation of the sound waves generated by the exciter. However, for example, the supply and/or the discharge to the tool coupling can extend in the longitudinal direction through the sound propagation channel. Since no separate actuator, such as a push rod, has to be provided between the exciter and the atomizing membrane, the atomizing membrane can be set in vibration in a particularly energy-saving manner and can be driven in rotation by a simple shaft. Although in principle different shapes can be provided for the atomizing membrane, there are design advantages if the atomizing membrane is of circular design. The material for the atomizing membrane can be gold, for example, or other flexible and corrosion-resistant materials. The exciter may be a sound source connected to an amplifier. Depending on the application, the frequencies generated in this way can be in the human hearing frequency range or in the ultrasonic range.

Particularly favorable design conditions result if the supply line opens into the side of the atomizing membrane of the atomizing device facing away from the tool coupling. Preferably, the orifice is arranged at the center of rotation of the atomizing membrane, which enables uniform distribution of the coating agent as a result of the rotation of the atomizing membrane.

Flow simulations and light sheet microscopy images have shown that the coating agent particles detaching from the coating agent carrier generate turbulences in the area between the atomizing device and a workpiece to be coated. These turbulences influence the flow direction of the subsequently detached coating agent particles, resulting in an irregular coating of the workpiece. Therefore, in order to avoid mutual interference between coating agent particles detached one after the other in time, it is proposed that the atomizing device has a suction head connected to the discharge line. In this case, the atomizing membrane can have a suction membrane section that has apertures to the suction head located downstream of the atomizing membrane. If a negative pressure is applied to the discharge line via the tool coupling, the air provided with undesirable turbulence is drawn through the apertures into the suction head, resulting in rectification or dissolution of the turbulence. In this way, homogeneous flow conditions are established in the area above the atomizing membrane, enabling a uniformly thick coating of a workpiece. In order to suck in as few coating agent particles as possible, the suction can take place in a pulsed manner. In the case of a round atomizing membrane, longitudinal slots extending tangentially to the round atomizing membrane have proved particularly suitable as apertures. For uniform suction, several suction membrane sections can be provided, which are evenly distributed over the atomizing membrane.

In order to ensure color fastness even in the applied state when using many different paint colors as processing media, it is proposed that the coupling attachments each have two channels for different processing media. The processing medium for coating, for example the paint color, can be fed into one channel, while a vacuum can be applied as the processing medium in the other channel. In this way, the supply line leading to the atomizing membrane of the atomizing device can be cleaned with the aid of the negative pressure before the line segments and thus the processing media are changed. In addition, there is the advantage that by applying a vacuum, a particularly tight connection is created between the coupling attachment of the line segment and the tool coupling. In a preferred embodiment, one of the at least two channels runs concentrically in the other, so that the channel opening of the inner channel is surrounded by the channel opening of the outer channel. In this way, the processing medium of the inner channel can be removed as uniformly as possible when a negative pressure is applied to the outer channel as the processing medium. In a particularly preferred embodiment, the coupling attachment is designed such that the channel opening of the outer channel protrudes beyond the channel opening of the inner channel. In this case, the channel opening of the inner channel can open into the outer channel and preferably be arranged concentrically to the channel opening of the outer channel.

### BRIEF DESCRIPTION OF THE INVENTION

In the drawing, the subject matter of the invention is shown by way of example, wherein:

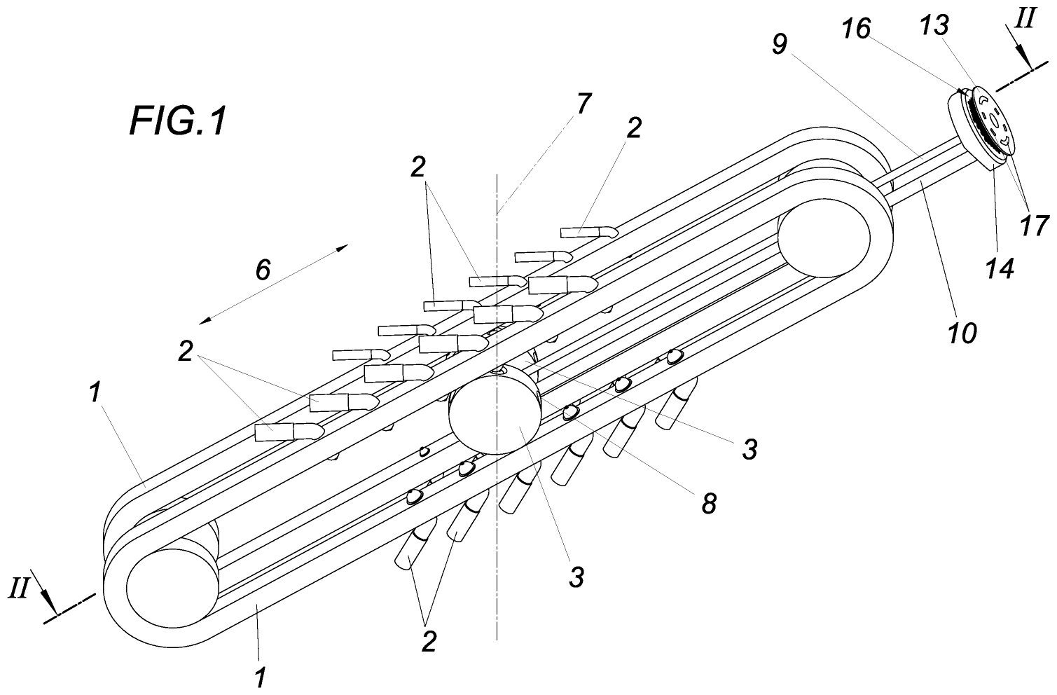

FIG. 1 shows a perspective view of a device for changing processing media according to the invention,

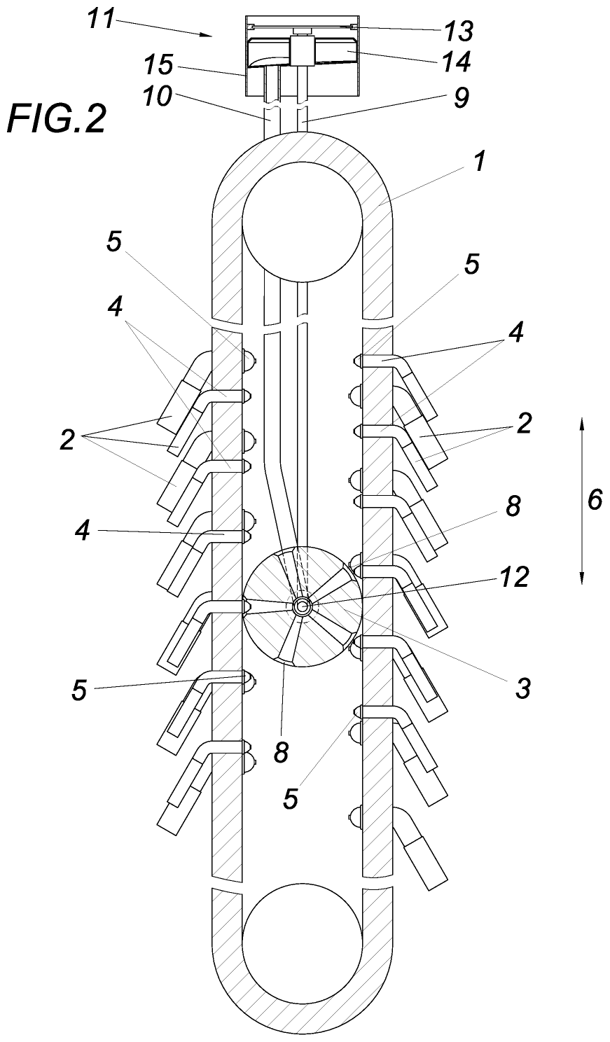

FIG. 2 shows a schematic section along line II-II on a larger scale, with the suction head and the atomizing membrane arranged in a housing, and

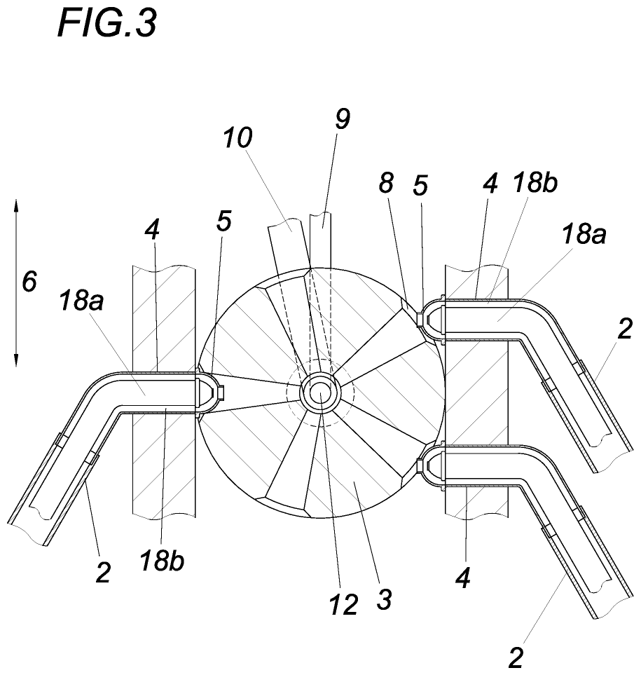

FIG. 3 shows a section of a schematic cross-section through an alternative embodiment of the device according to the invention on an enlarged scale.

### DETAILED DESCRIPTION OF THE PREFERRED EMBODIMENTS

A device according to the invention for changing processing media has, as can be seen in FIG. 1, a displaceable carrier 1 on which several supply connections 2 are arranged. By displacing the carrier 1, the supply connections 2 can be displaced relative to a tool coupling 3 and coupled thereto, whereby processing media provided via the supply connections 2 can be conveyed via the tool coupling 3 to any consumers. A particularly rapid and structurally simple change between different supply connections 2 is achieved, as disclosed in FIG. 2, according to the invention in that the supply connections 2 arranged on the carrier outer side are connected to line segments 4 passing through the carrier 1, which in turn open into coupling receptacles 5 arranged on the carrier inner side. As a result of the fact that the tool coupling 3 is mounted rotatably about an axis of rotation 7 extending parallel to the carrier 1 and normal to the direction of displacement 6, when the carrier 1 is displaced in the direction of displacement 6, the coupling attachments 5, which are flow-connected to the supply connections 2 via the line segments 4, can pivot in and out of coupling receptacles 8, arranged on the lateral surface, of the tool coupling 3 and thus create or release a fluid-tight connection with the tool coupling 3. In the coupled, fluid-tight position between coupling attachment 5 and coupling receptacle 8, various consumers can be supplied with different processing media via the tool coupling 3.

Due to the sectional tangential course of the carrier 1 along the tool coupling 3, the coupling and uncoupling of the coupling attachments 5 can therefore take place by displacing the carrier 1 in only one direction within small travel ranges. The displacement can be effected by driving the carrier 1 or the tool coupling 3, wherein the tool coupling 3 or the carrier 1 can be driven by frictional and/or positive engagement.

As is disclosed in particular in FIG. 2, the tool coupling 3 can be flow-connected to a supply line 9 and/or a discharge line 10 of an atomizing device 11. Via the supply line 9, the atomizing device 11 can be supplied with coating media, such as liquid or powder paint, as a processing medium. Via the discharge line 10, the atomizing device 11 can be supplied with negative pressure as processing medium, which enables, for example, easy cleaning of the atomizing device 11. The supply line 9 and/or the discharge line 10 can be flow-connected to the tool coupling 3 via a hollow shaft 12, about which the tool coupling 3 rotates. The hollow shaft 12 may have openings on the lateral surface for this purpose, with the openings being arranged in such a way that a fluid connection between coupling receptacles 8 and the hollow shaft 12 is only made possible when the coupling receptacle 8 is fully coupled to a coupling attachment 5.

FIG. 1 shows that two tool couplings 3 can be provided, wherein one tool coupling 3 is flow-connected to the supply line 9 and the other tool coupling 3 is flow-connected to the discharge line 10. In this way, an atomizing device 11 can be supplied with two different processing media simultaneously. Via the supply line 9, the atomizing device can be supplied with a coating medium which is atomized into fine particles by the atomizing device, while the discharge line 10 can apply a gas flow or negative pressure to the atomizing device 11 to influence the flow behavior of the atomized particles. Each tool coupling 3 may be associated with its own carrier 1, allowing them to be relocated independently. For example, one carrier 1 may include supply connections 2 for negative pressure or gaseous processing media, while the other carrier 1 may include supply connections 2 for coating media. Typically, the diameters of the supply connections 2 for the coating media have a larger diameter than those for providing the vacuum or gaseous processing media.

In order to be able to accommodate a particularly large number of supply connections 2 in the device according to the invention without having to accept losses with regard to a fast changeover process between different processing media, two carriers 1 can be provided which are opposite each other with regard to the tool coupling 3 and which move in opposite directions. Preferably, the opposing carriers 1 can be two runs of a revolving belt drive. Due to the carriers 1 facing each other, the tool coupling 3 can be connected in a fluid-tight manner from two sides with the coupling attachments 5 and thus with the supply connections 2, which, with appropriate arrangement of the coupling attachments 5 and coupling receptacles 8, further shortens the travel distance when changing the processing media.

A particularly fast changeover process can be achieved if the coupling attachments 5 of the opposing carriers 1 are offset from each other by a gap, as can be seen in particular in FIG. 2.

In order that the device according to the invention can be installed in a compact manner in, for example, a robot arm, the carrier 1 can extend in a longitudinal direction. The atomizing device 11 can be positioned downstream of the carrier 1 and the tool coupling 3 in this longitudinal direction.

In particular, it can be seen from FIG. 2 that the supply line 9 for supplying processing media to a rotationally driven atomizing membrane 13 can open into the atomizing membrane 13. In order to achieve a uniform distribution of the coating medium over the entire surface of the atomizing membrane 13, the supply line 9 can open into the center of the atomizing membrane 13.

In order to be able to rectify turbulence upstream of the atomizing device 11, and thus improve the coating quality, a suction head 14 can be provided, which is flow-connected to the discharge line 10. The suction head 14 may comprise a housing 15 in which the atomizing membrane 13 is arranged. Negative pressure can be applied to the atomizing device 11 via suction openings 16 (FIG. 1). As a result, turbulences in front of the atomizing device 11 can subsequently be rectified via apertures 17, into which the air located in front of the atomizing device 11 is sucked.

FIG. 3 shows an alternative embodiment of the device according to the invention. In this embodiment, the coupling attachments 5 have two channels 18a, 18b running into each other for different processing media. In the inner channel 18a, for example, a paint can flow as a processing medium. A vacuum can be applied in the outer channel 18b. In this way, the supply line 9, which is connected via the tool coupling 3 to the coupling attachment 5 of the line segment 4, can be cleaned. Further, by applying the negative pressure, a tight connection can be created between the coupling attachment 5 and the tool coupling 3, so that leakages can be avoided. The coupling attachments 5, which can be connected to the discharge line 10 via the tool coupling 3, can also have channels 18a, 18b for different processing media running into one another. This makes it possible, for example, to switch quickly between different vacuum levels.

1. A device for changing processing media, said device comprising:
a plurality of supply connections arranged on a common carrier and displaceable relative to a tool coupling in a displacement direction;
said carrier having a carrier outer side and a carrier inner side opposite thereto;
wherein the carrier is traversed by line segments that, on the carrier outer side, have supply connections and, on the carrier inner side, have coupling attachments configured to coact with coupling receptacles of the tool coupling that are arranged on a lateral surface thereof; and
wherein said tool coupling is mounted rotatably about an axis of rotation extending parallel to the carrier and normal to the displacement direction.

2. The device according to claim 1, wherein the tool coupling is flow-connected to a supply line (9) or a discharge line of an atomizing device.

3. The device according to claim 1, wherein the device has a second tool, and one of the tool couplings is flow-connected to the supply line of an atomizing device and another of the tool couplings is flow-connected to a discharge line of an atomizing device.

4. The device according to claim 1, wherein the device has another carrier opposite the carrier with respect to the tool coupling, and said another carrier supports additional coupling attachments.

5. The device according to claim 4, wherein the carriers are two runs of a revolving belt drive.

6. The device according to claim 4, wherein the coupling attachments of one of the carriers are staggered relative to the coupling attachments of the other of the carriers.

7. The device according to claim 2, wherein the carrier extends in a longitudinal direction and the atomizing device is arranged downstream of the carrier and the tool coupling in said longitudinal direction.

8. The device according to claim 2, wherein the supply line opens into a side of an atomizing membrane of the atomizing device facing away from the tool coupling.

9. The device according to claim 2, wherein the atomizing device has a suction head connected to the discharge line and forming suction openings open towards an atomizing membrane of the atomizing device.

10. The device according to claim 1, wherein the coupling attachments each have two channels receiving different processing media.

11. The device according to claim 10, wherein one of the two channels extends in the other of the two channels, wherein the outer channel is subjected to negative pressure as a processing medium.

12. The device according to claim 2, wherein the device has a second tool, and one of the tool couplings is flow-connected to the supply line of the atomizing device and another of the tool couplings is flow-connected to the discharge line of the atomizing device.

13. The device according to claim 2, wherein the device has another carrier opposite the carrier with respect to the tool coupling, and said another carrier supports additional coupling attachments.

14. The device according to claim 3, wherein the device has another carrier opposite the carrier with respect to the tool coupling, and said another carrier supports additional coupling attachments.

15. The device according to claim 12, wherein the device has another carrier opposite the carrier with respect to the tool coupling, and said another carrier supports additional coupling attachments.

16. The device according to claim 13, wherein the carriers are two runs of a revolving belt drive.

17. The device according to claim 14, wherein the carriers are two runs of a revolving belt drive.

18. The device according to claim 15, wherein the carriers are two runs of a revolving belt drive.

19. The device according to claim 5, wherein the coupling attachments of one of the carriers are staggered relative to the coupling attachments of the other of the carriers.

20. The device according to claim 16, wherein the coupling attachments of one of the carriers are staggered relative to the coupling attachments of the other of the carriers.
